(19) United States
(12) Patent Application Publication
(10) Pub. No.: US 2019/0213464 A9
(43) Pub. Date: Jul. 11, 2019

(54) Artificial Intelligence Support for Sufferers of Cognitive Dysfunction

(71) Applicant: Robert Polkowski, Boston, MA (US)

(72) Inventor: Robert Polkowski, Boston, MA (US)

(21) Appl. No.: 15/196,943

(22) Filed: Jun. 29, 2016

Related U.S. Application Data
(60) Provisional application No. 62/186,370, filed on Jun. 30, 2015.

(51) Int. Cl. G06N 3/00; G06N 99/00; G06N 5/04

(52) U.S. Cl. CPC G06N 3/006; G06N 5/04; G06N 99/005

(57) ABSTRACT

An artificial intelligence support system for a sufferer of cognitive dysfunction is disclosed. The system includes an assistant device configured to interact with the sufferer, one or more family members or one or more close friends to obtain a plurality information. The system further includes a cognitive ecosystem configured to execute one or more preprogrammed routines based on a need of the sufferer. The cognitive ecosystem is also configured to make prediction and learn continuously based on the plurality of information using one or more artificial intelligence techniques. The cognitive ecosystem is further configured to activate one or more functions upon detecting the need, wherein the one or more functions comprises at least one of reminders or assistance in speaking.

### CROSS-REFERENCE TO RELATED APPLICATION

This application claims the benefit of U.S. Provisional Application No. 15/196,943, filed on Jun. 29, 2016.

### BACKGROUND

Embodiments of the present disclosure relates to artificial intelligence systems, and more particularly to artificial intelligence systems to support individuals afflicted with cognitive dysfunctions.

Artificial Intelligence is broadly defined as “the power of a machine to copy intelligent human behavior”. Cognitive dysfunction is a category of mental health disorders which primarily affects cognitive abilities including learning, memory, perception, and problem solving. The disorders progress gradually, affecting different areas of the brain at an increasing rate. A sufferer affected by mild cognitive dysfunction is generally prescribed medications which are known to slow the progress or alleviate the symptoms of the underlying disease and once the severity of the conditions increases, family members or nursing professionals are required for constant supervision and care.

In one instance, a sufferer of degenerative brain disorders, such as, Alzheimer's, is unable to recall the dates and events. For example, the sufferer making plans to visit her parents will need to be reminded of the current date, and the fact that the parents have both passed away years earlier. In another instance, the sufferers of cognitive dysfunction face conditions which affect the sufferer's ability to comprehend and produce speech. In some instances, the sufferer of cognitive dysfunction is unable to perform basic functions required for independent living, such as paying bills, taking medication, personal hygiene, and other everyday tasks and require assistance.

### BREIF DESCRIPTION

In accordance with an embodiment of the present disclosure, an artificial intelligence support system for a sufferer of cognitive dysfunction is provided. The system includes an assistant device configured to interact with the sufferer, one or more family members or one or more close friends to obtain a plurality information. The system further includes a cognitive ecosystem configured to execute one or more preprogrammed routines based on a need of the sufferer. The cognitive ecosystem is also configured to make prediction and learn continuously based on the plurality of information using one or more artificial intelligence techniques. The cognitive ecosystem is further configured to activate one or more functions upon detecting the need, wherein the one or more functions comprises at least one of reminders or assistance in speaking.

### BREIF DESCRIPTION OF DRAWINGS

The disclosure will be described and explained with additional specificity and detail with the accompanying figures in which:

FIG. 1 is a block diagram of an artificial intelligence support system in accordance with an embodiment of the present disclosure.

### DETAILED DESCRIPTION

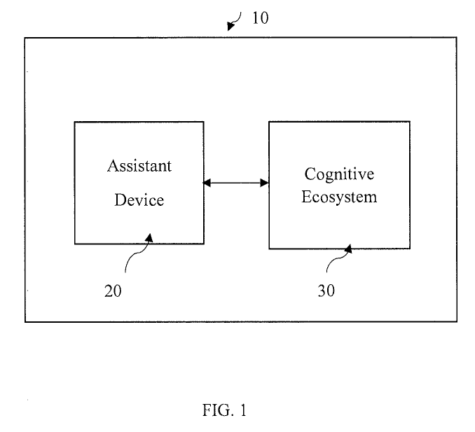

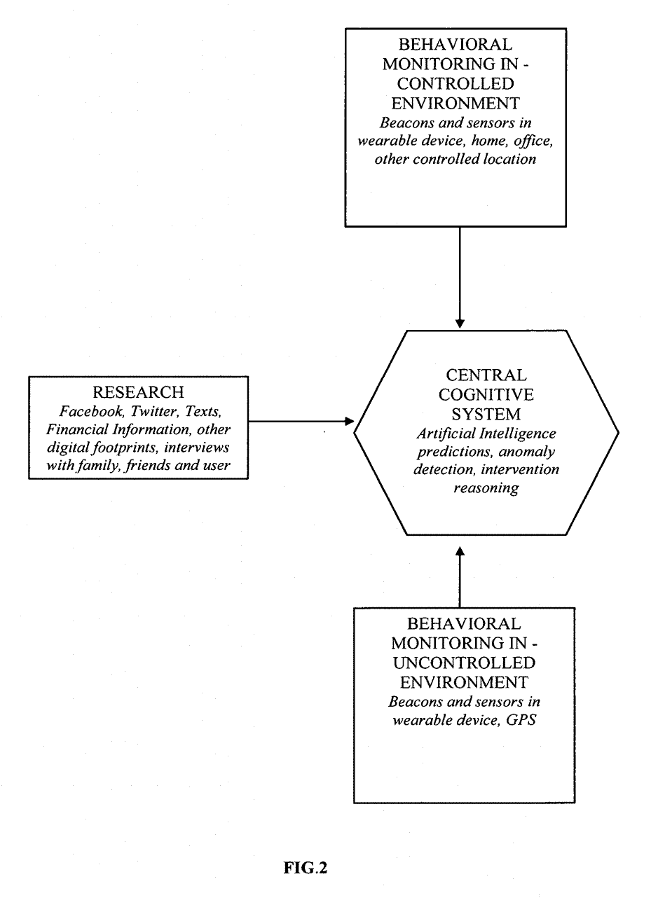

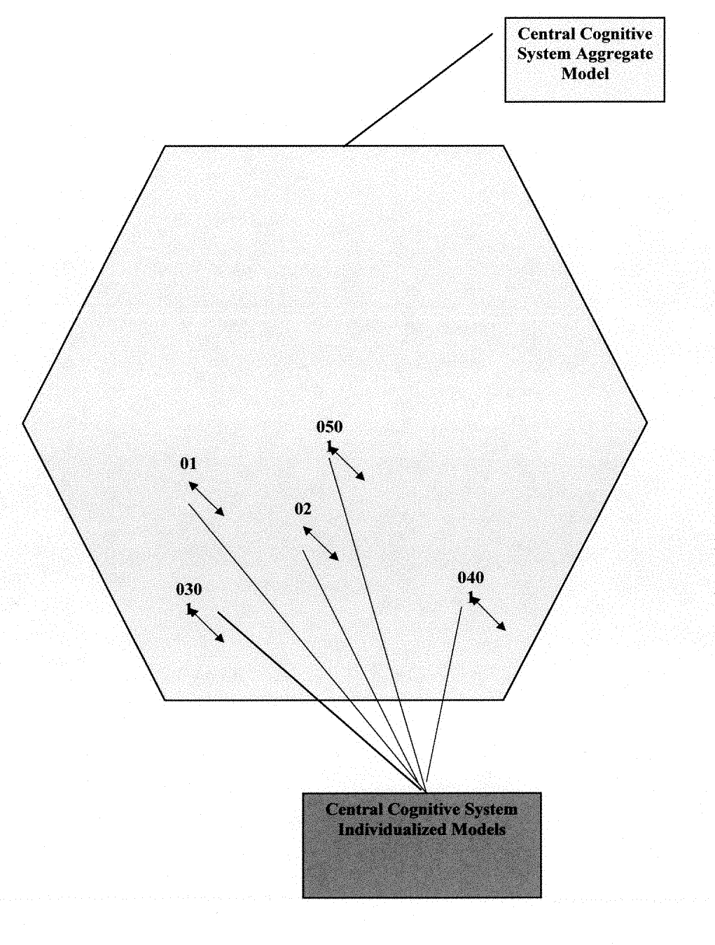

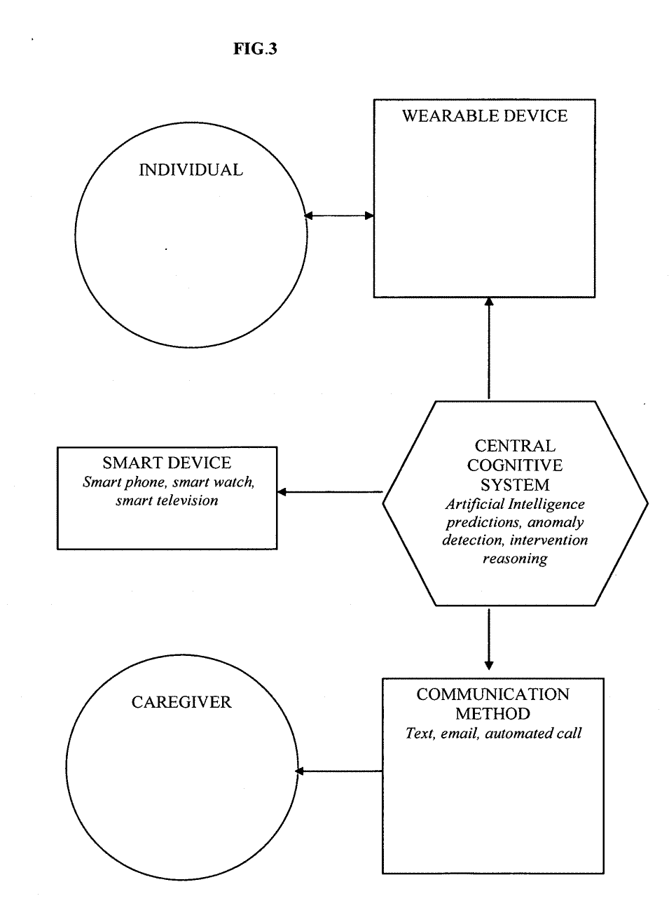

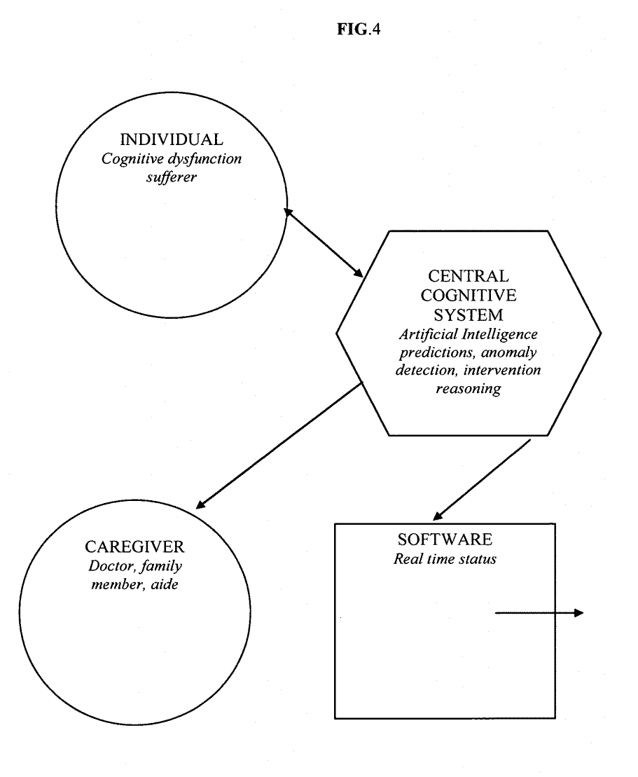

FIG. 1 is a block diagram of an artificial intelligence support system 10 in accordance with an embodiment of the present disclosure. The system 10 includes an assistant device 20 configured to interact with the sufferer, one or more family members or one or more close friends to obtain a plurality information. The interaction between the artificial intelligence support system 10 and the subject can occur in a variety of ways. The assistant device 20 is configured to receive the plurality of information by narrating life stories from sufferer and asking family members and close friends to do the same. In one embodiment, the assistant device 20 may include a wearable device.

Furthermore, the system 10 includes a cognitive ecosystem 30 operatively coupled to the assistant device 20 and retain the memories and subjects in sufferer's personal life, such as profiles of family members and friends, correlated with the experiences shared together. The sufferer is an individual who experiences cognitive dysfunction, as a result of any event such as accident, natural decay or environmental causes. As the disorders progress, the cognitive support system 10 gauge the needs of the sufferer and provide context as necessary. The cognitive ecosystem is configured to execute one or more preprogrammed routines based on a need of the sufferer. The cognitive ecosystem 30 is also configured to make prediction and learn continuously based on the plurality of information using one or more artificial intelligence techniques. In one embodiment, the one or more artificial intelligence techniques may include machine learning techniques, deep learning techniques, and other artificial Intelligence techniques. The cognitive ecosystem 30 is further configured to activate one or more functions upon detecting the need, wherein the one or more functions comprises at least one of reminders or assistance in speaking.

In one embodiment, the cognitive ecosystem 30 may be configured to provide assistance to complete sentences or locate words the sufferer is unable to recall, thereby making it possible for the individual to communicate effectively. Depending on the severity of the intervention required, the cognitive ecosystem 30 may deliver a message through the wearable, engage in a conversation via the wearable, play a video, a song or another trigger in the wearable, a smartphone device, or any other device connected via Bluetooth or another technology.

In another embodiment, the cognitive ecosystem 30 assist the sufferer by ensuring that basic functions required for independent living, such as paying bills, taking medication, personal hygiene, and other everyday tasks, are completed by providing the appropriate reminders. In a specific embodiment, the artificial intelligence support system 10 may also be represented as a computer program, or a television device entity. In some embodiments, the cognitive ecosystem 30 may be located on a cloud server.

We claim:

1. An artificial intelligence support system for a sufferer of cognitive dysfunction comprising:
An assistant device configured to interact with the sufferer, one or more family members or one or more close friends to obtain a plurality of information; and
a cognitive ecosystem operatively coupled to the assistant device and configured to:
execute one or more preprogrammed routines based on a need of the sufferer;
make prediction and learn continuously based on the plurality of information using one or more artificial intelligence techniques;
activate one or more functions upon detecting the need, wherein the one or more functions comprises at least one of reminders or assistance in speaking.
